(19) United States
(12) Patent Application Publication
(10) Pub. No.: US 2021/0019853 A1
(43) Pub. Date: Jan. 21, 2021

(54) SYSTEM AND METHOD FOR SOLICITING AT LEAST ONE BID FROM MOBILITY AS A SERVICE PROVIDER SYSTEMS

(71) Applicant: c/o Toyota Motor North America, Inc., Plano, TX (US)

(72) Inventors: Juan Acosta, The Colony, TX (US); Randall M. Harris, Dallas, TX (US); Equan T. Tompkins, Aubrey, TX (US)

(21) Appl. No.: 16/512,737

(22) Filed: Jul. 16, 2019

(51) Int. Cl. G06Q 50/30; G06Q 30/06

(52) U.S. Cl. CPC G06Q 50/30; G06Q 30/0611

(57) ABSTRACT

A system for soliciting at least one bid from Mobility as a Service provider systems includes one or more processors and a memory in communication with the one or more processors that stores a front end module and a back end module. The front end module includes instructions that cause the one or more processors to receive trip request information for a trip from a passenger via a user interface of a device. The back end module includes instructions that cause the one or more processors to receive a bid from one of the MaaS provider systems in response to the trip request information and transmit the bid to the MaaS provider systems that did not provide the bid. The bid may include a price for providing transportation services for the passenger based on the trip request information.

### TECHNICAL FIELD

The subject matter described herein relates, in general, to a system and method for soliciting at least one bid from Mobility as a Service (“MaaS”) provider systems.

### BACKGROUND

The background description provided is to present the context of the disclosure generally. Work of the inventor, to the extent it may be described in this background section, and aspects of the description that may not otherwise qualify as prior art at the time of filing, are neither expressly nor impliedly admitted as prior art against the present technology.

MaaS providers, sometimes referred to as ridesharing or ride-hailing services, function to match passengers with vehicles, usually via websites and mobile applications. MaaS providers may receive transportation requests from passengers for ridesharing services. This request may include a pickup location and a destination. In response to these requests, MaaS providers provide a price for the transportation request to the passenger. This price may be a “take it or leave it” price, wherein the passenger either accepts the transportation service at the provided price or declines the service altogether.

### SUMMARY

This section generally summarizes the disclosure and is not a comprehensive explanation of its full scope or all its features.

A system for soliciting at least one bid from MaaS provider systems includes one or more processors and a memory in communication with the one or more processors that stores a front end module and a back end module. The front end module includes instructions that cause the one or more processors to receive trip request information for a trip from a passenger via a user interface of a device. The back end module includes instructions that cause the one or more processors to receive a bid from one of the MaaS provider systems in response to the trip request information and transmit the bid to the MaaS provider systems that did not provide the bid. The bid may include a price for providing transportation services for the passenger based on the trip request information.

A method for soliciting at least one bid from MaaS provider systems includes the steps of receiving trip request information for a trip from a passenger via a user interface of a device, receiving a bid from one of the MaaS provider systems in response to the trip request information, and transmitting the bid to the MaaS provider systems that did not provide the bid.

A non-transitory computer-readable medium for soliciting at least one bid from MaaS provider systems includes instructions that when executed by one or more processors cause the one or more processors to receive trip request information for a trip from a passenger via a user interface of a device, receive a bid from one of the MaaS provider systems in response to the trip request information, and transmit the bid to the MaaS provider systems that did not provide the bid.

Further areas of applicability and various methods of enhancing the disclosed technology will become apparent from the description provided. The description and specific examples in this summary are intended for illustration only and are not intended to limit the scope of the present disclosure.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates a block diagram of a general overview of a MaaS system for soliciting at least one bid from MaaS provider systems;

FIG. 2 is a more detailed block diagram of a MaaS system for soliciting at least one bid from MaaS provider systems;

FIGS. 3A-3D illustrates different examples of a user interface of a device displaying bids from MaaS provider systems; and

FIG. 4 illustrates an example of a method for soliciting at least one bid from MaaS provider systems.

### DETAILED DESCRIPTION

A MaaS system and method described herein allows for a passenger to provide trip information to multiple MaaS providers regarding a trip. The trip information may include an origin, sometimes referred to as a pickup location, and a destination. One or more of the MaaS providers may respond to the trip information by providing a bid for transportation services related to the trip. The bid for transportation services is provided to the other MaaS providers, to encourage the other MaaS providers to make competitive bids. These bids may then be provided to the passenger so the passenger can select which MaaS provider they wish to utilize for their trip. The bids to provide transportation services offered by the MaaS providers may be bundled together to include transportation for different portions of the trip. These different portions of the trip may utilize different modes of transportation, such as automobile, airplane, scooter, bicycle, etc.

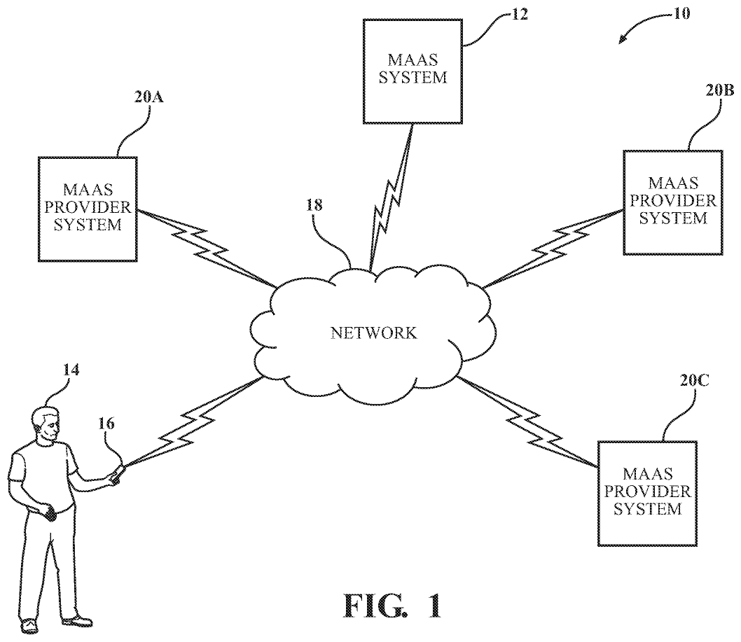

Referring to FIG. 1, a system 10 illustrating a general overview for soliciting one or more bids from MaaS provider systems 20A-20C is shown. Here, the system includes a MaaS system 12, MaaS provider systems 20A-20C, and a passenger 14 utilizing a device 16. The MaaS system 12, MaaS provider systems 20A-20C, and the device 16 utilized by the passenger 14 may communicate with each other via a network 18. The network 18 may be a distributed network, such as the Internet. It should be understood the system 10 is merely an example. There may be several MaaS provider systems, and not just three MaaS provider systems 20A-20C as shown. In addition, there may be several MaaS systems 12 and passengers 14 utilizing a device 16.

The MaaS provider systems 20A-20C may be systems utilized by MaaS providers for receiving trip requests from potential passengers, such as passenger 14. The MaaS provider systems 20A-20C may then collect this information, provide a bid for performing the trip associated with the trip request, and then dispatch the appropriate assets, such as ridesharing vehicles, to perform the trip. The ridesharing vehicles can include any of several vehicles. For example, the ridesharing vehicles could be an automobile, truck, heavy-duty truck, tractor-trailer, tractor, mining vehicle, military vehicle, bicycle, scooter, motorcycle, and the like. In addition, the ridesharing vehicles may not be limited to ground-based vehicles but could also include aircraft and seagoing vessels as well.

As explained in greater detail later in this specification, in one example, the passenger 14 utilizing the device 16 provides trip information regarding a trip the passenger 14 wishes to take. The trip information could include an origin, sometimes referred to as a pickup location, and a destination. This trip information may be provided to the MaaS system 12, which then provides this trip information to the MaaS provider systems 20A-20C.

The MaaS provider systems 20A-20C may then generate bids for providing services to complete the trip associated with the trip information. The bids generated by one of the MaaS provider systems 20A-20C may be shared with the other MaaS provider systems to create a competitive environment where the MaaS provider systems 20A-20C compete to provide the most competitive bid. Overall, the system can function to provide better pricing and use of assets while reducing price surges. This approach provides a metasearch for MaaS providers with coordinated back end services to facilitate competition through bidding for passengers.

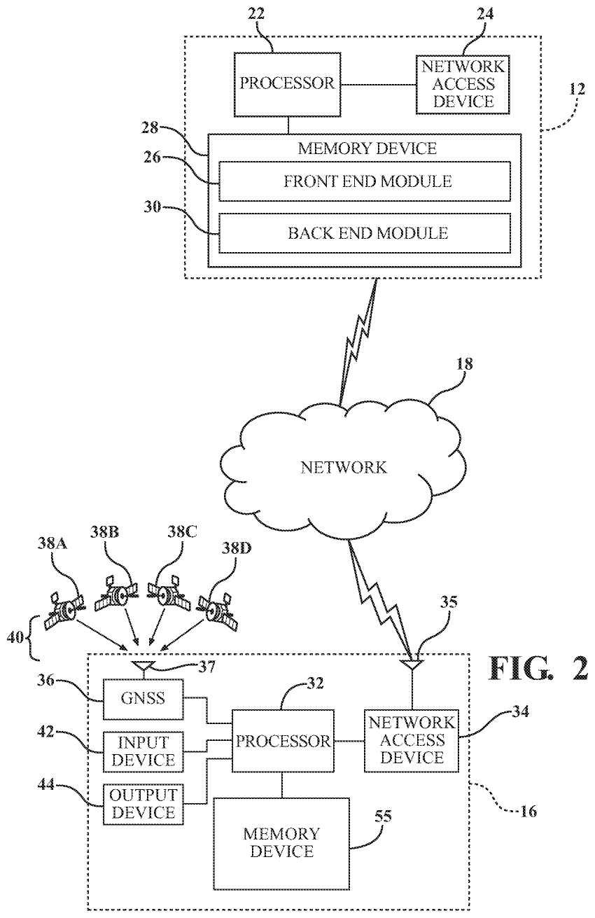

Referring to FIG. 2, a more detailed illustration of the MaaS system 12 and the device 16 are shown. Reference will also be made to FIG. 1 when describing the more detailed illustration of the MaaS system 12 and the device 16.

The MaaS system 12 may include one or more processors 22, a network access device 24 in communication with the one or more processors 22, and a memory device 26 in communication with the one or more processors 22. The network access device 24 may be an electronic device, such as a circuit, that connects the one or more processors 22 a to network 18, such as the Internet. The network access device 24 may include any equipment required to connect to a wide area network from a local area network. The network access device 24 acts as a conduit that allows for the communication of the one or more processors 22 to communicate with several devices, such as the device 16 and/or the MaaS provider systems 20A-20C.

The memory device 26 may be any type of memory capable of storing information that can be utilized by the one or more processors 22. The memory device 26 may be a solid-state memory device, magnetic memory device, optical memory device, and the like. In this example, the memory device 26 is separate from the one or more processors 22, but it should be understood that the memory device 26 may be incorporated within any of the one or more processors 22, as opposed to being a separate device.

The memory device 26 may be capable of storing one or more modules that when executed by the one or more processors 22 cause the one or more processors 22 to perform any of several methods disclosed in this disclosure. In this example, the memory device 26 includes a front end module 28 and a back end module 30.

The front end module 28 may include instructions that when executed by the one or more processors 22 cause the one or more processors 22 to receive trip request information for a trip from a passenger 14 via a user interface of a device, such as the device 16. The front end module 28 may provide a metasearch tool that aggregates services for a ride across all MaaS providers. As one example, the passenger 14 may input attributes of a route including a destination, a starting location, preferences (e.g., type of preferred services), time, etc. into the device 16. These attributes may form all or part of the trip request information provided by the MaaS system 12 to the MaaS provider systems 20A-20C. The front end module 28 may then return options including combinations of multiple services for the trip. The services returned may be arranged by shortest, fewest provider transitions, cheapest, etc.

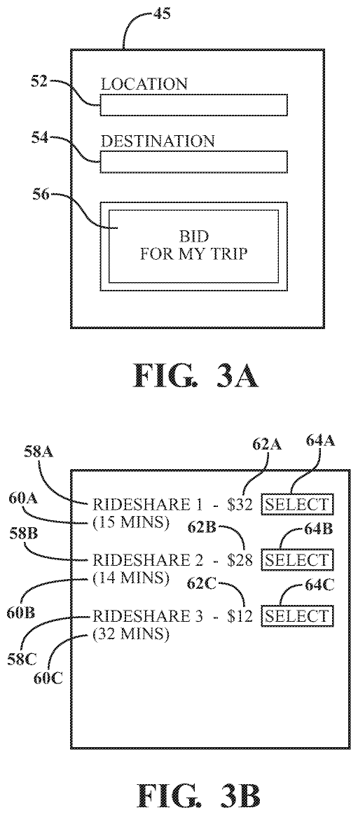

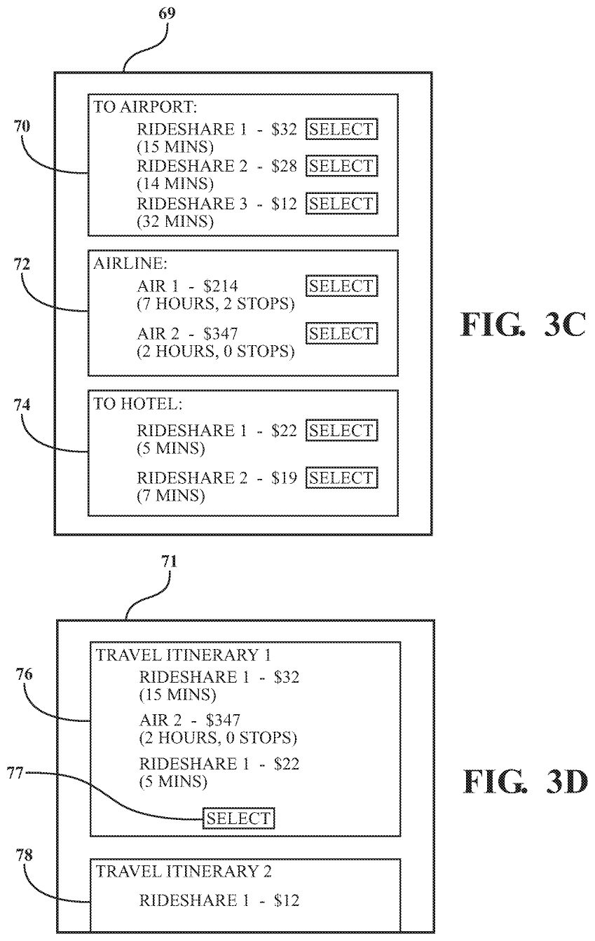

For example, referring to FIG. 3A, a user interface 45 may include an origin entry portion 52 for receiving a location, which could be the origin or pickup location for the passenger. The user interface 45 may also include a destination data entry portion 54, which allows a passenger 14 to input the destination. A bid icon 56 allows one to transmit the location input into the origin entry portion 52 and the destination inputted into the destination data entry portion 54 to the MaaS system 12. This information will then be provided as trip information to the MaaS provider systems 20A-20C of FIG. 1.

It should be understood that the user interface 45 of FIG. 3A is merely an example. In addition to providing both origin and destination information, the user interface 45 may also allow the passenger 14 to input additional attributes such as types of services, modes of transportation, carpooling options, disability requests, or other attributes. These attributes can also be provided to the MaaS system 12 in the trip information.

The back end module 30 may include instructions when executed by the one or more processors 22 cause the one or more processors 22 to provide an interface through which MaaS provider systems 20A-20C can dynamically set prices or ranges of prices depending on their current supply versus demand or according to any desired factors. Accordingly, the separate MaaS provider systems 20A-20C, can adjust fares in relation to those of other providers displayed within the search tool to “bid” for the passengers. This bidding can involve selectively offering different combinations of services, reduced rates on services from areas of low demand into areas of higher demand, and so on. The back end module 30 can include instructions that can provide an aggregator for current prices of other competitors and/or user profiles for those requesting passengers.

In one example, the back end module 30 may include instructions when executed by the one or more processors 22 cause the one or more processors 22 to receive a first bid from one of the MaaS provider systems 20A-20C in response to the trip request information. The first bid may include a price for providing transportation services for the passenger 14 based on the trip request information, and transmit the first bid to the MaaS provider systems that did not provide the first bid. The back end module 30 may further include instructions when executed by the one or more processors 22 cause the one or more processors to receive a second bid from one of the other MaaS provider systems that did not provide the first bid. The second bid may include a price for providing transportation services for the passenger 14 based on the trip request information. The back end module 30 may further transmit the second bid to the MaaS provider systems that did not provide the second bid. From there, MaaS provider systems 20A-20C may provide additional bids which will then be provided to the other MaaS provider systems. By providing the bids to the other MaaS provider systems, the other MaaS provider systems can then bid and/or adjust previous bids to provide a more compelling bid that is more likely to be accepted by the passenger 14.

Further, it should be understood the trip may be broken up into one or more sub trips. These sub trips may then be bid on separately by one or more MaaS provider systems. For example, the back end module 30 may further include instructions that cause the one or more processors 22 generate a plurality of sub trips that form the trip. The sub trips may require transportation services provided by at least one of the MaaS provider systems. The back end module 30 may then include instructions that cause the one or more processors 22 transmit the plurality of sub trips to the MaaS provider systems 20A-20C.

From there, the MaaS system 12 may then receive at least one sub trip bid from at least one of the MaaS provider systems 20A-20C for the sub trips and transmit the sub trip bid to the MaaS provider systems 20A-20C that did not provide the sub trip bid. As such, by sharing the bid for the sub trips with the other MaaS provider systems 20A-20C, the MaaS provider systems 20A-20C can then competitively bid for the sub trips. The sub trips may utilize a plurality of modes of transportation from the MaaS provider systems, such as automobile, airplane, bicycles, and/or scooters.

After the bids from the MaaS provider systems 20A-20C are received by the MaaS system 12, the front end module 28 of the MaaS system 12 may then provide the bids to the device 16 where they can be displayed on a user interface. For example, referring to FIG. 3B, a user interface 57 illustrating the bids provided by the MaaS provider systems 20A-20C are shown. Here, for example, three bids are shown. The first bid displayed on the user interface 57 illustrates an identity 58A of the MaaS provider, a time 60A for the asset, such as a ridesharing vehicle, to arrive to pick up the passenger 14, and a price 62A for the service. If the passenger 14 desires to accept this bid, the passenger selects icon 64A, which then transmits the passenger's acceptance of the bid to the MaaS service provider responsible for the bid.

Similarly, the same is generally true for the other two bids displayed on the user interface 57. Like before, the second and third bids displayed on the user interface 57 illustrates an identity 50B and 50C of the MaaS provider, a time 60B and 60C for the asset, such as a ridesharing vehicle, to pick up the passenger 14, and a price 62B and 62C for the service. If the passenger 14 desires to accept one of these bids, the passenger selects icon 64B or 64C, which then transmits the passenger's acceptance of the bid to the MaaS service provider responsible for the bid.

The back end module 30 may further include instructions that when executed by the one or more processors 22 cause the one or more processors 22 to generate one or more travel itineraries. A travel itinerary may be a collection of different transportation services required to complete the trip. For example, assume that in order to complete a trip, transportation must be made from the present location of the passenger 14 to a first airport, air transportation from the first airport to a second airport, then transportation from the second airport to a destination, such as a hotel. In this example, the travel itinerary would include three sub trips—transportation to the first airport, the flight from the first airport to the second airport, and transportation from the second airport to the final destination.

Each sub trip could include one or more bids from the MaaS service provider systems 20A-20C. The travel itinerary could be transmitted to the device 16 so that the passenger of the device 16 could view the travel itinerary and each bid for each sub trip. The transmission of the travel itinerary may be performed by the front end module 28.

For example, referring to FIG. 3C, the user interface 69 displays three separate sub trips 70, 72, and 74. The first sub trip 70 is a trip to an airport and includes three separate bids. The second sub trip 72 illustrates an airline trip with two separate bids. The third sub trip 74 is a trip from the airport to the final destination and displays two bids. Similar to the description provided for the user interface 57 of FIG. 3B, the passenger 14 simply selects one of the bids for each of the sub trip 70, 72, and 74. This then causes the one or more processors 22 of the MaaS system 12 to then transmit the passenger's acceptance of the bids for each sub trip to the MaaS service provider responsible for the bid.

The back end module 30 could also include instructions to select one of the sub trip bids for each sub trip based on a desirability factor. The desirability factor includes at least one of price of the at least one sub trip bid, trip duration associated with the at least one sub trip bid, number of stops associated with the at least one sub trip bid, and time of trip associated with the at least one sub trip bid.

Additionally or alternatively, instead of breaking the trip itinerary into sub trips, the back end module 30 could include instructions to combine the sub trips into package deals. These package deals could include at least one bid for each sub trip. A package deal may include one bid for each sub trip. For example, MaaS service providers may have agreements with other transportation service providers, such as airlines. These MaaS service providers may submit bids for the entire travel itinerary and not just for a sub trip.

For example, referring to FIG. 3D, the user interface 71 displays a first package travel itinerary 76 and a second package travel itinerary 78. Each of the package travel itinerary 76 and 78 will include one bid for each of the sub trips. If the user desires to select the travel itinerary 76, with the prepackaged bids for each of the sub trips, the user simply selects the icon 77.

Thus, the separate MaaS providers system 20A-20C can link the back end module 30 into their respective systems from which they can determine current demand, availability, etc. Using the noted factors, the system can provide individualized prices back to the driver to bid for the passenger competitively. In further aspects, a first MaaS service provider may combine offers with a second service provider to provide possible routes that optimize trips of the Uber vehicle that maintain the vehicle in high demand locations while also efficiently inducing use of secondary MaaS providers (bike-shares, mass transit).

Additionally, it should be understood that the MaaS system 12 may be incorporated within the device 16 and/. As such, the device 16 would also contain a processor and a memory device that includes the front end module 28 and/or the back end module 30. The device 16 would perform any of the operations performed by the MaaS system 12.

Further, the modules 28 and/or 30 could be a component of the one or more processors 22 or one or more of the modules 28 and/or 30 can be executed on and/or distributed among other processing systems to which the one or more processors 22 are operatively connected. For example, the device 16 and/or the MaaS provider systems 20A-20C could also execute and/or be included in the distribution among other processing systems to which the one or more processors 22 are operatively connected.

As to the device 16, the device 16 may be a mobile device, such as a mobile phone, that is operated by the passenger 14. The device 16 may include one or more processors 32 in communication with a network access device 34, a global navigation satellite system (“GNSS”) 36, an input device 42, an output device 44, and a memory device 55. The network access device 34 allows the one or more processors 32 of the device 16 to communicate with the network 18, such as the Internet. As such, the network access device 34 may be any one of a number of different components that allow the transmission of information to the network 18 and therefore to other electronic systems and subsystems connected to the network 18. These electronic systems and subsystems could include the MaaS system 12 and/or the MaaS provider systems 20A-20C. The network access device 34 may be connected to an antenna 35 that allows for the wireless transmission and reception of data from the device 16.

The GNSS system 36 may be a satellite navigation system that provides autonomous geo-spatial positioning with global coverage. The GNSS system 36 may include any one of a number of different GNSS systems, such as GPS, GLONASS, Galileo, Beidou or other regional systems. The GNSS system 36 may be connected to an antenna 37 that is capable of receiving one or more signals 40 from one or more satellites 38A-38D. Based on the one or more signals 40 from one or more satellites 38A-38D, the GNSS system 36 can determine the relative location of the device 16 to which the GNSS system is installed. This relative location may be in the form of a coordinate system that may indicate the latitude, longitude, and/or altitude of the device 16 that has the GNSS system 36 installed within.

As such, the GNSS system 36 allows for one or more processors 32 to determine the relative location of the device 16, and then relay this information to MaaS system 12 and/or the MaaS provider systems 20A-20C via the network access device 34. This may be useful in situations where the location of the device 16 from the GNSS system 36 can be assumed to be the original

The input device 42 may be any type of device that allows the passenger to provide information to the one or more processors 32 of the device 16. As such, the input device 42 may be a touchscreen and/or keyboard that allows the passenger to provide information to the one or more processors 32. The type of information that may be provided from the passenger via the input device 42 may include, for example, the rideshare request from the passenger that includes the origin and the destination, types of services, modes of transportation, carpooling options, disability requests, or other attributes.

The output device 44 may be any type of device that allows the passenger to receive information from the one or more processors 32 of the device 16. The information from the one or more processors 32 could be information that originated from the MaaS system 12. In one example, the output device 44 may be a display device that visually displays information to the driver or passenger. Additionally, it should be understood that the input device 42 and the output device 44 may be incorporated as a touchscreen that allows for inputting information from the passenger as well as displaying information to the passenger. The information displayed by the output device 44 could include the user interfaces 45, 57, 69, and 71 illustrated in FIGS. 3A-3D, respectively.

The memory device 55 may include instructions and/or modules for executing any one of a number of functions including the methods disclosed in this specification. For example, the modules 28 and/or 30 may be stored within the memory device 55. As such, the device 16 may perform some and/or all the functionality of the MaaS system 12.

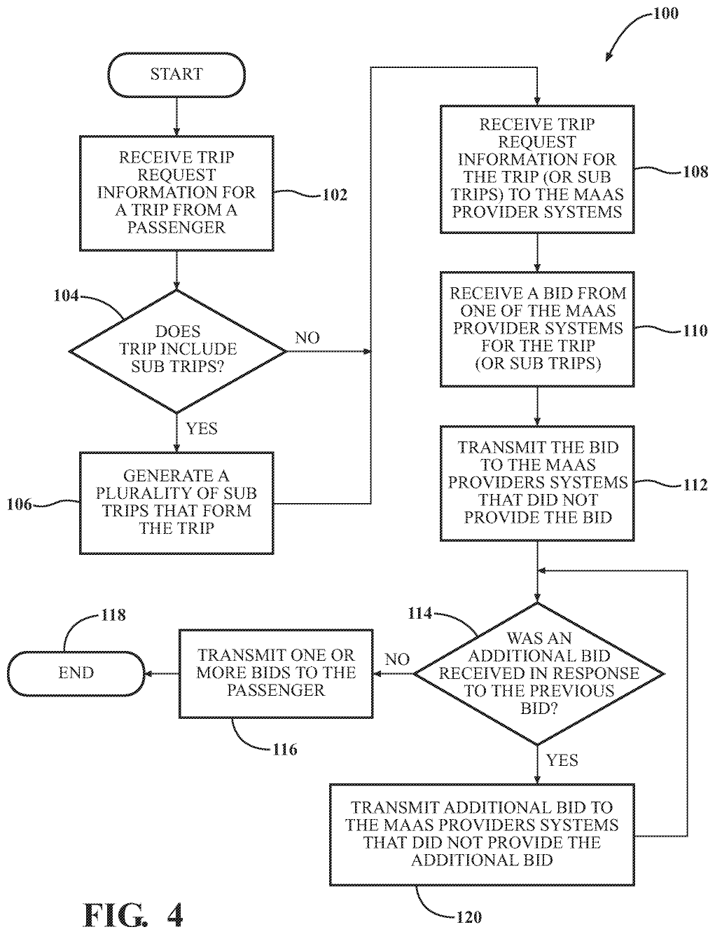

Referring to FIG. 4, one example of a method 100 for soliciting at least one bid from MaaS provider systems, such as MaaS provider systems 20A-20C will be discussed from the perspective of the MaaS system 12 of FIGS. 1-2. While the method 100 is discussed in combination with the MaaS system 12, it should be appreciated that the method 100 is not limited to being implemented within the MaaS system 12 but is instead one example of a system that may implement the method 100.

The method 100 starts at step 102, wherein the front end module 28 may receive trip request information for a trip from the passenger 14 via the device 16. The trip request information may include an origin, sometimes referred to as a pickup location, and a destination. In addition to this information, the trip request information may include information relating to different types of services requested, modes of transportation, carpooling options, disability requests, or other attributes.

In step 104, the back end module 30 determines if the trip includes sub trips. In some situations, the trip may require or may have requested by the passenger 14 to be broken up into sub trips. Each sub trip may be able to move the passenger 14 partly from the origin to the destination. For example, a trip may include three sub trips—transportation by a vehicle to a first airport, transportation by a plane from the first airport to a second airport, and transportation by a vehicle from the second airport to the destination. If it is determined that the trip does not include sub trips, the method 100 continues to step 108; otherwise, the method proceeds to step 106.

In step 106, the back end module 30 generates a plurality of sub trips that form the trip. In step 108, the one or more processors 22 of the MaaS system 12 transmit trip request information for the trip (or sub trips) to the MaaS provider systems 20A-20C. The MaaS provider systems 20A-20C receive requests for transportation from the passengers 14 and dispatch vehicles or other modes of transportation to be utilized by the passengers 14.

In step 110, the back end module 30 may receive a bid from one or more of the MaaS provider systems 20A-20C for the trip (or sub trips). In step 112, the back end module 30 transmits the received bid to the MaaS provider systems 20A-20C that did not provide the bid. By so doing, the MaaS provider systems 20A-20C that did not provide the bid are made aware of the bid and the price of the bid for the services requested by the passenger 14.

In step 114, the back end module 30 determines if an additional bid (or second bid) is received in response to the previous bid. For example, as stated previously, the method 100 in step 112 transmitted the initial bid (which may be referred to as the previous bid in this example) to the other MaaS service provider systems 20A-20C. In response to the initial bid, the other MaaS provider systems 20A-20C may decide to provide an additional bid so as to compete against the previous bid. If an additional bid is received, the the back end module 302 in step 120 transmits the additional bid to the other MaaS provider systems 20A-20C so as to inform the other MaaS provider systems 20A-20C of the additional bid. This may, in turn, encourage the other MaaS provider systems 20A-20C to generate even further bids and/or modify any previously offered bids so as to create a competitive environment benefiting the passenger 14 with a reduced cost or better services.

After no additional bids are received by the one or more processors 22 of the MaaS system 12, the method 100 proceeds to step 116 wherein the front end module 28 transmits the bids to the passenger 14. The transmission of the bids to the passenger 14 may be done by providing the bids to the device 16, wherein the device 16 will display the bids as shown, for example, in FIGS. 3A-3D. Thereafter, the passenger 14 can select which bid they deem most attractive and the method 100 ends as indicated in step 118.

It should be appreciated that any of the systems described in this specification can be configured in various arrangements with separate integrated circuits and/or chips. The circuits are connected via connection paths to provide for communicating signals between the separate circuits. Of course, while separate integrated circuits are discussed, in various embodiments, the circuits may be integrated into a common integrated circuit board. Additionally, the integrated circuits may be combined into fewer integrated circuits or divided into more integrated circuits.

In another embodiment, the described methods and/or their equivalents may be implemented with computer-executable instructions. Thus, in one embodiment, a non-transitory computer-readable medium is configured with stored computer executable instructions that when executed by a machine (e.g., processor, computer, and so on) cause the machine (and/or associated components) to perform the method.

While for purposes of simplicity of explanation, the illustrated methodologies in the figures are shown and described as a series of blocks, it is to be appreciated that the methodologies are not limited by the order of the blocks, as some blocks can occur in different orders and/or concurrently with other blocks from that shown and described. Moreover, less than all the illustrated blocks may be used to implement an example methodology. Blocks may be combined or separated into multiple components. Furthermore, additional and/or alternative methodologies can employ additional blocks that are not illustrated.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer readable program code embodied, e.g., stored, thereon. Any combination of one or more computer-readable media may be utilized. The computer-readable medium may be a computer readable signal medium or a computer-readable storage medium. The phrase “computer-readable storage medium” means a non-transitory storage medium. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Examples of such a computer-readable medium may include, but are not limited to, a floppy disk, a flexible disk, a hard disk, a magnetic tape, other magnetic medium, an ASIC, a graphics processing unit (GPU), a CD, other optical medium, a RAM, a ROM, a memory chip or card, a memory stick, and other media from which a computer, a processor or other electronic device can read. In the context of this document, a computer-readable storage medium may be any tangible medium that can contain or store a program for use by or in connection with an instruction execution system, apparatus, or device.

The following includes definitions of selected terms employed herein. The definitions include various examples and/or forms of components that fall within the scope of a term, and that may be used for various implementations. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Module,” as used herein, includes a computer or electrical hardware component(s), firmware, a non-transitory computer-readable medium that stores instructions, and/or combinations of these components configured to perform a function(s) or an action(s), and/or to cause a function or action from another logic, method, and/or system. Module may include a microprocessor controlled by an algorithm, a discrete logic (e.g., ASIC), an analog circuit, a digital circuit, a programmed logic device, a memory device including instructions that when executed perform an algorithm, and so on. A module, in one or more embodiments, may include one or more CMOS gates, combinations of gates, or other circuit components. Where multiple modules are described, one or more embodiments may include incorporating the multiple modules into one physical module component. Similarly, where a single module is described, one or more embodiments distribute the single module between multiple physical components.

Additionally, module, as used herein, includes routines, programs, objects, components, data structures, and so on that perform tasks or implement data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), as a graphics processing unit (GPU), or as another suitable hardware component that is embedded with a defined configuration set (e.g., instructions) for performing the disclosed functions.

In one or more arrangements, one or more of the modules described herein can include artificial or computational intelligence elements, e.g., neural network, fuzzy logic, or other machine learning algorithms. Further, in one or more arrangements, one or more of the modules can be distributed among a plurality of the modules described herein. In one or more arrangements, two or more of the modules described herein can be combined into a single module.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A method for soliciting at least one bid from Mobility as a Service (“MaaS”) provider systems, the method comprising the steps of:
receiving trip request information for a trip from a passenger inputted via a user interface of a device;
receiving a first bid from one of the MaaS provider systems in response to the trip request information, the first bid including a price for providing transportation services for the passenger based on the trip request information; and
transmitting the first bid to the MaaS provider systems that did not provide the first bid.

2. The method of claim 1, further comprising the step of receiving a second bid from one of the other MaaS provider systems that did not provide the first bid, the second bid including a price for providing transportation services for the passenger based on the trip request information.

3. The method of claim 2, further comprising the step of transmitting the second bid to the MaaS provider systems that did not provide the second bid.

4. The method of claim 1, further comprising the steps of:
generating a plurality of sub trips that form the trip, wherein the sub trips require transportation services provided by at least one of the MaaS provider systems;
transmitting the plurality of sub trips to the MaaS provider systems;
receiving at least one sub trip bid from at least one of the MaaS provider systems for the sub trips; and
transmitting the sub trip bid to the MaaS provider systems that did not provide the sub trip bid.

5. The method of claim 4, wherein the sub trips utilize a plurality of modes of transportation from the MaaS provider systems.

6. The method of claim 5, further comprising the steps of:
generating at least one trip itinerary, wherein the trip itinerary includes at least one sub trip bid for each of the sub trips; and
transmitting the at least one trip itinerary to the user interface on the device.

7. The method of claim 6, further comprising the step of selecting one of the at least one sub trip bid for each sub trip on a desirability factor.

8. The method of claim 7, were the desirability factor includes at least one of price of the at least one sub trip bid, trip duration associated with the at least one sub trip bid, number of stops associated with the at least one sub trip bid, and time of trip associated with the at least one sub trip bid.

9. A system for soliciting at least one bid from Mobility as a Service (“MaaS”) provider systems, the system comprising:
one or more processors;
a memory in communication with the one or more processors and storing;
a front end module including instructions when executed by the one or more processors cause the one or more processors to receive trip request information for a trip from a passenger inputted via a user interface of a device; and
a back end module including instructions when executed by the one or more processors cause the one or more processors to receive a first bid from one of the MaaS provider systems in response to the trip request information, the first bid including a price for providing transportation services for the passenger based on the trip request information, and transmit the first bid to the MaaS provider systems that did not provide the first bid.

10. The system of claim 9, wherein the back end module further comprises instructions when executed by the one or more processors cause the one or more processors to receive a second bid from one of the other MaaS provider systems that did not provide the first bid, the second bid including a price for providing transportation services for the passenger based on the trip request information.

11. The system of claim 10, wherein the back end module further comprises instructions when executed by the one or more processors cause the one or more processors to transmit the second bid to the MaaS provider systems that did not provide the second bid.

12. The system of claim 9, wherein the back end module further comprises instructions when executed by the one or more processors cause the one or more processors to:
generate a plurality of sub trips that form the trip, wherein the sub trips require transportation services provided by at least one of the MaaS provider systems;
transmit the plurality of sub trips to the MaaS provider systems;
receive at least one sub trip bid from at least one of the MaaS provider systems for the sub trips; and
transmit the sub trip bid to the MaaS provider systems that did not provide the sub trip bid.

13. The system of claim 12, wherein the sub trips utilize a plurality of modes of transportation from the MaaS provider systems.

14. The system of claim 12, wherein the back end module further comprises instructions when executed by the one or more processors cause the one or more processors to:
generate at least one trip itinerary, wherein the trip itinerary includes at least one sub trip bid for each of the sub trips; and
transmit the at least one trip itinerary to the user interface on the device.

15. The system of claim 14, wherein the back end module further comprises instructions when executed by the one or more processors cause the one or more processors to select one of the at least one sub trip bid for each sub trip on a desirability factor.

16. The system of claim 15, were the desirability factor includes at least one of price of the at least one sub trip bid, trip duration associated with the at least one sub trip bid, number of stops associated with the at least one sub trip bid, and time of trip associated with the at least one sub trip bid.

17. A non-transitory computer-readable medium for soliciting at least one bid from Mobility as a Service (“MaaS”) provider systems and including instructions that when executed by one or more processors cause the one or more processors to:
receive trip request information for a trip from a passenger inputted via a user interface of a device;
receive a first bid from one of the MaaS provider systems in response to the trip request information, the first bid including a price for providing transportation services for the passenger based on the trip request information; and
transmit the first bid to the MaaS provider systems that did not provide the first bid.

18. The non-transitory computer-readable medium of claim 17, further including instructions that when executed by one or more processors cause the one or more processors to receive a second bid from one of the other MaaS provider systems that did not provide the first bid, the second bid including a price for providing transportation services for the passenger based on the trip request information.

19. The non-transitory computer-readable medium of claim 18, further including instructions that when executed by one or more processors cause the one or more processors to transmit the second bid to the MaaS provider systems that did not provide the second bid.

20. The non-transitory computer-readable medium of claim 19, further including instructions that when executed by one or more processors cause the one or more processors to:
generate a plurality of sub trips that form the trip, wherein the sub trips require transportation services provided by at least one of the MaaS provider systems;
transmit the plurality of sub trips to the MaaS provider systems;
receive at least one sub trip bid from at least one of the MaaS provider systems for the sub trips; and
transmit the sub trip bid to the MaaS provider systems that did not provide the sub trip bid.
